(19) United States
(12) Patent Application Publication
(10) Pub. No.: US 2016/0055491 A1
(43) Pub. Date: Feb. 25, 2016

(54) OBJECT OPINION REGISTERING DEVICE FOR GUIDING A PERSON IN A DECISION MAKING SITUATION

(71) Applicant: KONINKLIJKE PHILIPS N.V., Eindhoven (NL)

(72) Inventors: MURTAZA BULUT, EINDHOVEN (NL); BJÖRN NICOLASS SERVATIUS VLASKAMP, 'sHERTOGENBOSCH (NL); ARMIN GERHARD KOHLRAUSCH, EINDHOVEN (NL); RUSLAN AKHMEDOVICH SEPKHANOV, EINDHOVEN (NL); RAYMOND VAN EE, GELDROP (NL)

(73) Assignee: KONINKLIJKE PHILIPS N.V.

(21) Appl. No.: 14/784,061

(22) PCT Filed: Apr. 9, 2014
(86) PCT No.: PCT/IB2014/060544

§ 371 Date: Oct. 13, 2015

Related U.S. Application Data
(60) Provisional application No. 61/811,183, filed on Apr. 12, 2013.

(51) Int. Cl. G06Q 30/02

(52) U.S. Cl. CPC G06Q 30/0201

(57) ABSTRACT

The present invention relates to an object opinion registering device (20) for guiding a person in a decision making situation involving one or more physical objects (10A-10F), the object opinion registering device (20) being arranged to register opinion indications of each of the one or more physical objects (10A-10F), and the object opinion registering device comprising a controller (26) arranged to control at least one object indicator (30) arranged to physically highlight a physical object (10B), among the one or more physical objects (10A-10F), based on registered opinion indications of each of the one or more physical objects (10A-10F).

### FIELD OF THE INVENTION

The present invention relates to an object opinion registering device and a system for guiding a person in a decision making situation involving one or more physical objects.

### BACKGROUND OF THE INVENTION

Product marketing in stores may trigger a consumer to take a decision to buy a specific product while being in the store. For example it is well known that the display location for a specific product correlates with the number of sales for that specific product.

From a retailer's perspective product marketing at the display location implies that the product suppliers can focusing their marketing to be made in the store itself, instead of (or complementary to) marketing in traditional channels, such as advertisements in newspapers, TV or radio commercials, social media, etc. It has been shown for supermarkets that the majority of decisions on what product brand to choose are made while the consumer is visiting the store. Thus, by successful product marketing inside the store the sales of a specific product may be enhanced.

Product marketing is based on the understanding of the shopping behavior of consumers and is said to be dependant on product (size, shape, color, material, packaging, virtual identity, etc.), pricing (marking, price reduction, quantity discount, etc.), placing (store concept, lighting, placement of special presentations in the store, etc.) and promotion (advertising in shopping carts, shopping baskets and advertising pillars, etc.).

Typically, three different data collection methods are used for gathering information on consumer purchasing behavior: observations, interviews, and checkout systems. By observing how consumers behave in the store, information on when they buy a product, how long the buying process is, what products consumers notice, touch, examine and buy, and how their spending habits are affecting the shopping process may be gathered. Using interviews the motives that govern purchasing behavior, such as whether a specific product can be replaced with a similar one and how a substitute product may be recognized, values and attitudes during a purchase, preferences and motivational factors for purchasing a specific product, etc. may be clarified. By means of the checkout system it may be deduced which products are purchased. With the aid of e.g. a personal store card, an individual consumer's purchasing behavior may be mapped. Thus, precise information can be obtained concerning how and when a particular consumer has acted. The deepest understanding of consumer shopping behavior is obtained when the information is compiled from the above aforementioned collection methods, providing a comprehensive view of the consumer (how, why, what and when).

Despite the above mentioned knowledge on how to analyze consumer purchasing behavior and product marketing in stores, further tools for product marketing in stores in order for controlling or influencing the consumer purchasing behavior may be beneficial in order to achieve, for example, greater sales of specific products.

### SUMMARY OF THE INVENTION

It is an objective of the present invention to provide tools for product marketing in order to control, measure or influence consumer behavior. This may lead to, for example, achieving greater sales of specific products.

According to a first aspect of the invention, this and other objectives are achieved by an object opinion registering device arranged to register opinion indications related to one or more physical objects, the object opinion registering device comprising: an input for receiving an opinion indication related to the one or more physical objects; a controller, coupled to the input, arranged to register opinion indications received and further arranged to control an object indicator to physically highlight at least one of the one or more physical objects based on registered opinion indications.

In the course of this description the term physical object shall be interpreted as any kind of physical object. Non-limiting examples of a physical object are: a product displayed in a location where it is for sale (e.g. a product in a supermarket), a product displayed in a location where it is not for sale (e.g. a vase in a restaurant), an attraction (e.g. at an amusement park) or a piece of art at an exhibition (e.g. in a museum).

The object indicator may comprise a connection to a wired or wireless network and is further arranged to control an object indicator based on data received from a device coupled to the wired or wireless network. This is beneficial as the controller can use other data, such as sales data, to control the object indicator providing for improved product marketing.

The object indicator may comprise a connection to a wired or wireless network and is further arranged for a device connected to the wired or wireless network to access registered opinion indications. This is advantageous as registered opinion indications can be accessed by other devices, such as sales prediction systems, providing for improved product marketing.

The object indicator may comprise a lighting device arranged to physically highlight at least one of the one or more physical objects by directing light on the physical object(s). Attracting more attention from the person and increasing the chances that the object is noticed and bought is possible by increasing the lighting in the area where the object is on display. In an embodiment of the object opinion registering device according to the invention the lighting device is arranged to modulate intensity, color, color temperature, beam size and/or timing of the light directed on the at least one physical object. In addition, by application of several light modification techniques (e.g., to modify the saturation) the physical object can be made more noticeable amongst the others. In addition, by adding UV reflecting materials in the packaging or the name of the object (being e.g. a product), the brand can be highlighted by the light. The light can be static or dynamic. It can be presented in a congruent manner with other modalities, such as sound, to attract more attention and increase the stopping power.

The object indicator may comprise a sound generating device arranged to physically highlight at least one of the one or more physical objects by creating a local soundscape in the vicinity of the physical object(s). By creating a local soundscape in the area where the object is on display, the object attracts more attention from the person, increasing the chances that the object is noticed and bought. In an embodiment of the object opinion registering device according to the invention the sound generating device is arranged to modulate sound level, tempo, and/or content of the created local soundscape

The object opinion registering device may be arranged to register opinion indications by receiving opinion indications from at least one actuator coupled to the input, the actuator being related to at least one of the one or more physical objects, wherein the actuator is arranged to be actuated by persons indicating an opinion related to the at least one of the one or more physical objects. The at least one actuator may be able to register the rating of a physical object and accordingly the opinion indication of a physical object is linked to the number of actuations for the associated actuator. The actuators may e.g. be a like/dislike button arranged next to respective physical object. By using an actuator associated with one of the one or more physical objects it will be very easy for a person registering his or her opinion relating to a physical object. By placing the actuators next to the physical object a clear link between the physical object and the actuator are shown to the person's actuating the actuator.

The object opinion registering device may comprise at least one identification device arranged to register the identity of a person actuating said at least one actuator. This will allow for restricting a person to only assign one opinion per physical object, and thus gaining more accurate statistics on the popularity of the one or more physical objects. Alternatively or additionally this will allow registered opinions to be linked to specific customers, for use in, for example, a customer relationship management system or targeted advertising.

The object opinion registering device may be arranged to register opinion indications by receiving opinion indications from a smart device being arranged to be actuated by a person indicating an opinion related to at least one of the one or more physical objects. The smart device being a hand held device with processing power, e.g. a smart phone, a tablet, a watch, etc. Information regarding physical object(s) may be acquired by the smart device scanning e.g. a NFC tag, a bar code or a QR code. The smart device may be used to register such a code or tag and thereafter an application installed on the smart device may be arranged to communicate with the object opinion registering device e.g. via the interne, via a Bluetooth connection, etc.

The object opinion registering device may be arranged to register opinion indications by receiving opinion indications from information registered by a camera, wherein the information registered by the camera is used for intelligent shopping behavior analysis giving information regarding opinion indications related to at least one of the one or more physical objects (10A-10F). The intelligent shopping behavior analysis may e.g. be used for detecting the number of people that examine a specific physical object more than a preset number of seconds or the number of people picking up a specific physical object. By using a camera for registering opinion indication the persons need not to actively make a choice of rating a physical object. Instead the behaviors of the persons are used for deducing the opinion indication of persons.

According to a second aspect of the invention, the above and other objectives are achieved by a system arranged to register opinion indications related to one or more physical objects, the system comprising an object opinion registering device arranged to register opinion indications of at least one of the one or more physical objects, and at least one object indicator arranged to physically highlight a physical object, among the one or more of physical objects, based on registered opinion indications of at least one of the one or more physical objects registered by the object opinion registering device.

The above disclosed features of the first aspect are also applicable to this second aspect.

According to a third aspect of the invention, the above and other objectives are achieved by a system comprising a plurality of object opinion registering devices wherein the controller of at least one object opinion registering device of the plurality of object opinion registering devices is coupled to at least one other object opinion registering device of the plurality of object opinion registering devices and is further arranged to control an object indicator based on registered opinion indications of the at least one other object opinion registering device. This allows the physical highlighting of physical objects based on opinion indications across multiple object opinion registering devices, for example devices spread throughout a store (e.g. on different sides of a floor or on different floors) or devices across multiple stores (e.g. all product displays of a specific brand across the store in a geographical region).

The above disclosed features of the first aspect are also applicable to this third aspect.

According to a fourth aspect of the invention, the above and other objectives are achieved by a method for guiding a person in a decision making situation involving one or more physical objects, the method comprising: registering, by means of an object opinion registering device, opinion indications of at least one of the one or more physical objects, and physically highlighting, by means of an object indicator, a physical object, among the one or more physical objects, based on the registered opinion indications of at least one of the one or more physical objects.

The above disclosed features of the first aspect are also applicable to this fourth aspect.

According to a fifth aspect of the invention, the above and other objectives are achieved by a computer program product for guiding a person in a decision making situation related to one or more physical objects, the computer program product comprising computer program code for a programmable computer, the computer program code arranged for making the programmable computer perform the steps according to the method as per the third aspect of the invention, when said computer program is run on the programmable computer.

The above disclosed features of the first aspect are also applicable to this fifth aspect.

It is noted that the invention relates to all possible combinations of features recited in the claims.

### BRIEF DESCRIPTION OF THE DRAWINGS

These and other aspects of the present invention will now be described in more detail, with reference to the appended drawings showing embodiments of the invention.

FIG. 1 shows a schematic overview of a system for guiding a person in a decision making situation involving one or more physical objects according to the invention.

FIG. 2 shows a schematic overview of an alternative system for guiding a person in a decision making situation involving one or more physical objects according to the invention.

FIG. 3 shows a schematic overview of yet an alternative system for guiding a person in a decision making situation involving one or more physical objects according to the invention.

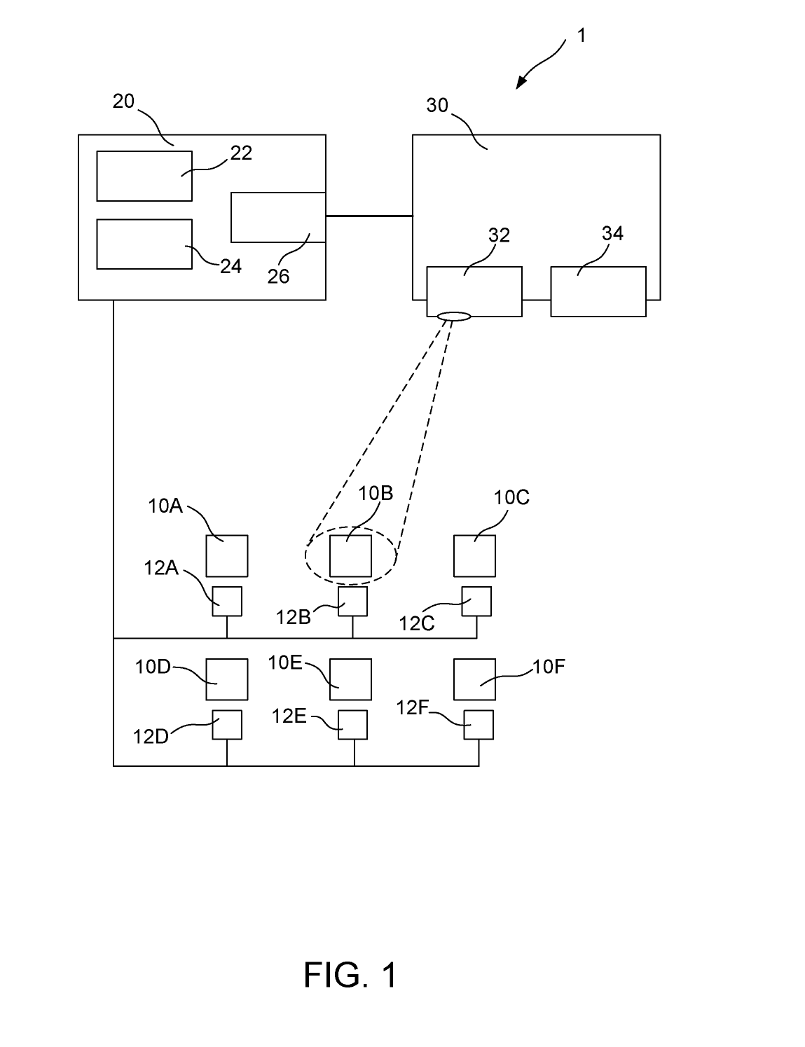

FIGS. 1-3 are purely diagrammatic and not drawn to scale. Particularly for clarity, some dimensions are exaggerated strongly.

FIG. 4 illustrates a method for guiding a person in a decision making situation involving one or more physical objects.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

The present invention is directed towards a system for guiding a person in a decision making situation involving one or more physical objects, especially choosing between one or more physical objects, such as choosing between one or more physical objects within a category of objects, e.g. choosing a specific hand bag model amongst one or more hand bag models, choosing a specific type of mobile phone model amongst one or more mobile phone models. The present invention is also directed towards an object opinion registering device to be used in such a system. The basic idea of the invention is to identify the most liked object(s) and to highlight it (them) with light and/or sound and/or other signals (e.g. visuals, scent, temperature or other means) according to how much or how often they are liked. This is made possible by enabling local change of the lighting and/or soundscape and/or other signals in a vicinity of an object based on the popularity of the object using a lighting device and/or a sound generating device and/or other signal generating devices.

By registering opinion indications of physical objects the popularity of a physical object may be determined. The above object opinion registering device can be applied in various shops such as supermarkets, fashion shops or consumer electronics shops. By identifying the most liked, touched, analyzed or sold objects, this can be indicated to other customers in the shop and in that way the number of customers interested in the object can be increased, generating a value (e.g. more revenue) for the store. By introducing the sense of social shopping, this can improve the shopping experience of the customers. For example, seeing that many people like a product will influence the person making him or her more likely to like the same product and thus possibly purchase the same product.

Having such information can be beneficial for retailers too. For example, by knowing the popularity of a product the location of the product of the shelf may be changed by the retailer. That is, popular products can be placed at popular places, e.g. half way between the shelf bottom and top to even further enhance sales of the product. Thus, the inventive object opinion registering device can prove to be very useful and accepted in a retail context. For example, people who are not sure what to purchase can now choose more easily between one or more similar products. Shop owners can obtain better understanding on how the products are perceived by customers, for example why products that are liked are not being sold more often (e.g. the price may be too high).

The technique of highlighting a product can also be applied to a specific aisle, or specific shelves in a store. Thus, when it is noticed that customers are more prone to crowd in a certain area, that area can be highlighted by light, sound, visuals, scent or other means. Similarly, when a certain shelf attracts more attention that can be highlighted as well.

The current invention introduces the concept of shared shopping in the retail context, by incorporating the possibility to indicate liking of a physical object, and by sharing the social feedback of “likes” by changing the physical parameters of the environment of the object. For example, highly-liked objects could be highlighted with light in such a way that their popularity or “status” can be perceived over larger distances. In addition, the acoustic environment of the object could be changed, e.g. by introducing subtle crowd-cheering sounds in the close vicinity of the object depending of the amount of “likes”. Thus, according to the present invention a system is provided, arranged to identify the most liked objects and highlight them with light and/or sound according to how much they are liked.

Below an implementation of the system for guiding a person in a decision making situation involving one or more physical objects using physical like buttons is described as a concrete example for the invention. The proposed idea can be generalized as changing the light and/or sound characteristics in real time to reflect the real time purchasing and/or customer behavior in the store. Other embodiments target the period over which “liking” hits are collected, e.g. current day, last week. The system can be adapted to include technologies as smart devices, image recognition, and fingerprint recognition to become more intelligent and user specific. For example instead of having a like button, near field communication (NFC) tags can be used. And the users can indicate their liking by “touching” the object (or the price tags or the shelf where the object is displayed, etc.) by their NFC capable smart device.

FIG. 1 illustrates an embodiment according to the present invention of a system 1 for guiding a person in a decision making situation involving one or more physical objects 10A-10F. The system 1 comprises an object opinion registering device 20, an object indicator 30 and one or more actuators 12A-12F. Each of the one or more actuators 12A-12F is associated with one of the one or more objects 10A-10F. The object indicator 30 is arranged to communicate with the object opinion registering device 20. Moreover, the one or more actuators 12A-12F are also arranged to communicate with the object opinion registering device 20. The communication may be implemented in various wired or wireless ways, known to the person skilled in the art and will thus not be explained in more detail.

The object opinion registering device 20 is arranged to register opinion indications of each of the one or more physical objects 10A-10F. For this purpose the object opinion registering device 20 is arranged to receive opinion indications from the one or more actuators 12A-12F. Each of the one or more actuators 12A-12F is arranged to be actuated by persons rating the object being associated with that specific actuator (or that setting of the actuator). A counter 22 of the object opinion registering device 20 is arranged to count the number and type of actuations for each of the one or more actuators 12A-12F, wherein the type of actuation is related to a person's opinion regarding a physical object. For example, the type of actuation may be related to if the person like or dislike the object, the like or dislike may even be graded e.g. on a scale 1-5. Alternatively, the type of actuation may be related to a rating of a physical object e.g. 4 out of 5 stars. The number and type of actuations for each of the one or more actuators 12A-12F is used for gaining the opinion indication of each of the one or more objects 10A-10F.

The actuators 12A-12F are installed next to, on or inside the respective object 10A-10F.

According to one specific embodiment each actuators 12A-12F comprises one like and one dislike button arranged next to respective object. Thus, by counting the number of actuations of the like button and the dislike button for each of the one or more actuators 12A-12F the opinion indication of each of the one or more physical objects 10A-10F is achieved by reducing the number of like indications with the number of dislike indications. Accordingly, persons can actuate an actuator 12A-12F associated with a specific object among the one or more physical objects 10A-10F in order to indicate that they like or dislike the object. The number and type actuations are recorded by the object opinion registering device 20.

To prevent the same person actuating a specific actuators 12A-12F multiple times the object opinion registering device 20 further comprises an identification device 24 arranged to register the identity of the person actuating the specific actuators 12A-12F. The identification device 24 may be implemented in various ways, thus several methods can be employed to count only unique actuations. For example, (i) a camera can be used to detect the person from face or posture, (ii) fingerprints can be analyzed, (iii) moving direction can detected, and only when moving towards and moving away pattern is detected the press can be considered as a valid one, (iv) users can be asked to scan their Bonus card/credit card/ID card, etc. (and maybe get additional discount when they like/dislike something), (v) users could be provided with a unique tag that has to be held against the actuators 12A-12F, or (vi) signals from a handheld device, e.g. a smart device, can be used to identify unique persons.

The object opinion registering device 20 further comprises a controller 26 arranged to control the object indicator 30. The object indicator 30 is arranged to physically highlight a physical object 10B, among the one or more physical objects 10A-10F, based on the opinion indications of each of the one or more physical objects 10A-10F registered by the object opinion registering device 20. The object indicator 30 comprises a lighting device 32 and a sound generating device 34.

The lighting device 32 is arranged to physically highlight the physical object 10B by directing light on the physical object 10B.

Attracting more attention from the person and increasing the chances that the object is noticed and bought is possible by increasing the lighting in the area where the object 10B is on display. The lighting device 32 is arranged to physically highlight the physical object 10B by modulating intensity, color, color temperature, beam size and/or timing of the light directed on the physical object 10B.

The sound generating device 34 is arranged to physically highlight the physical object 10B by creating a local soundscape in vicinity of the physical object 10B. By creating a local soundscape in the area where the object 10B is on display, attracts more attention from the person, increasing the chances that the object is noticed and bought. The sound generating device 34 is arranged to physically highlight the physical object 10B by modulating sound level, tempo, and/or content of the created local soundscape, e.g. by introducing subtle crowd-cheering sounds in the close vicinity of the object depending of the amount of “likes”. The sound is made local, thus in the vicinity of the object to be highlighted, in order to prevent annoyance for others by using loudspeaker arrays or ultrasonic loudspeakers.

Accordingly, changes in light and/or sound are done in a manner to reflect accumulated opinion indications as registered by the object opinion registering device 20. In FIG. 1 the changes in light are visualized as an increase in the light shining on object 10B, shown as the dotted line around object 10B.

In addition to being used in stores for guiding a person in a decision making situation involving one or more physical objects being on display in the store the above mentioned system can be used in public places to indicate liking for touristic attractions, liking for attractions in an amusement park, etc., the system can also be used in museums, art galleries and other places where physical objects are on display.

The feedback based on light/sound could be given in various modes depending on the time over which opinions are created. The chosen control parameter could indicate via e.g. a store's PA system, like: now we see the most-liked objects of the week; or: we now indicate the objects of today. Moreover, feedback can be given parallel to the smart device of the users, so the user can go to the most liked objects, this may be aided by navigation within the premises where the system is installed. Furthermore, the object opinion registering device may comprise a wired or wireless network connection to retrieve data from other devices (e.g. sales date from a cash register) that is used as basis for highlighting physical objects. Similarly, registered object opinion indications can be accessed over such a wired or wireless connection by other devices (e.g. an inventory control or ordering system).

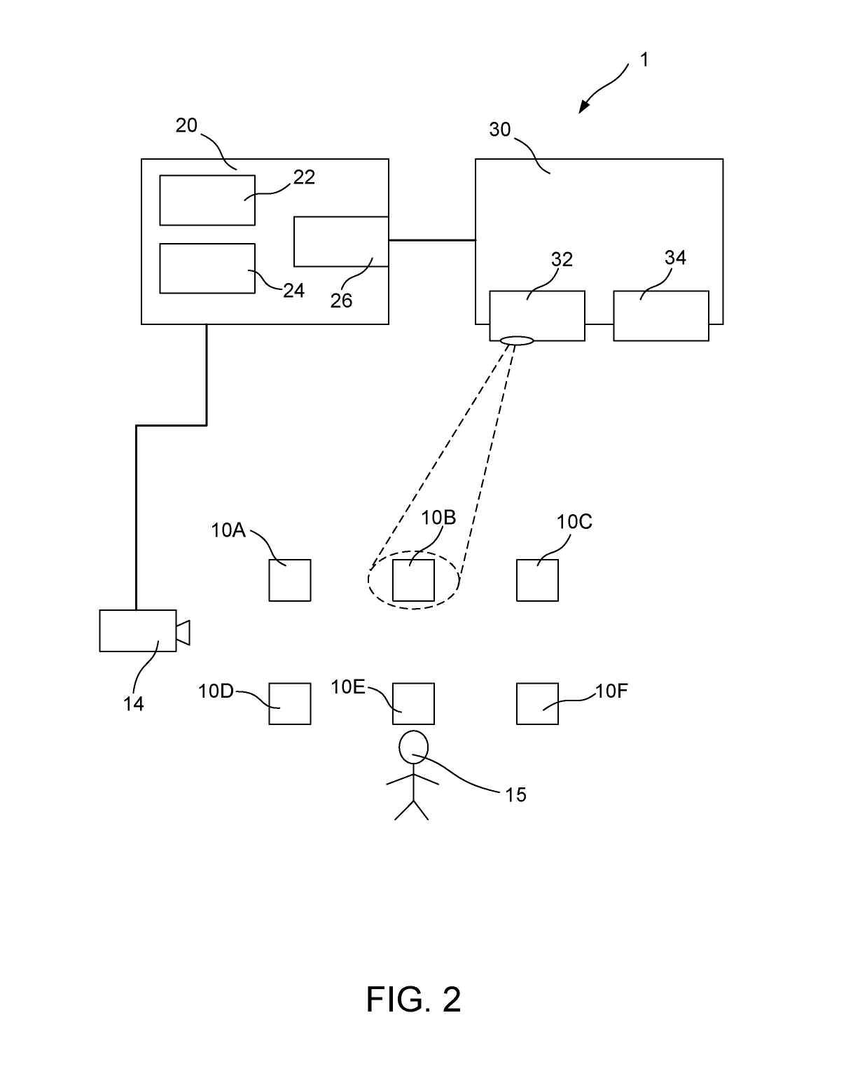

FIG. 2 illustrates an alternative embodiment of a system 1 for guiding a person in a decision making situation involving one or more physical objects 10A-10F. This embodiment resembles the system described in FIG. 1 but differ in that the object opinion registering device 20 according to this embodiment instead is arranged to receive opinion indications from one or more cameras 14. Thus, for details of the function of the object opinion registering device 20 and the object indicator 30 it is referenced to the above description. In FIG. 2. only one camera 14 is depicted but the person skilled in the art realizes that multiple cameras may be used as well. The one or more cameras 14 are arranged to communicate with the opinion registering device 20. The communication may be implemented in various wired or wireless ways, known to the person skilled in the art and will thus not be explained in more detail.

The one or more cameras 14 are arranged to monitor an area comprising the one or more physical objects 10A-10F. The information gained by the monitoring of the area comprising the one or more physical objects 10A-10F is used for intelligent shopping behavior analysis of the persons interacting with the one or more physical objects 10A-10F. The intelligent shopping behavior analysis is used for gaining information regarding opinion indications related to the one or more physical objects. The intelligent shopping behavior analysis may e.g. be used for detecting a person examining a specific physical object more than a preset number of seconds or a person picking up a specific physical object. The intelligent shopping behavior analysis may also be used for deducing the identity the person examining or picking up the physical object.

In FIG. 2. a person 15 is examining the physical object 10E more than a preset number of seconds and thus an opinion indication of that he is liking the physical object is deduced from the intelligent shopping behavior analysis.

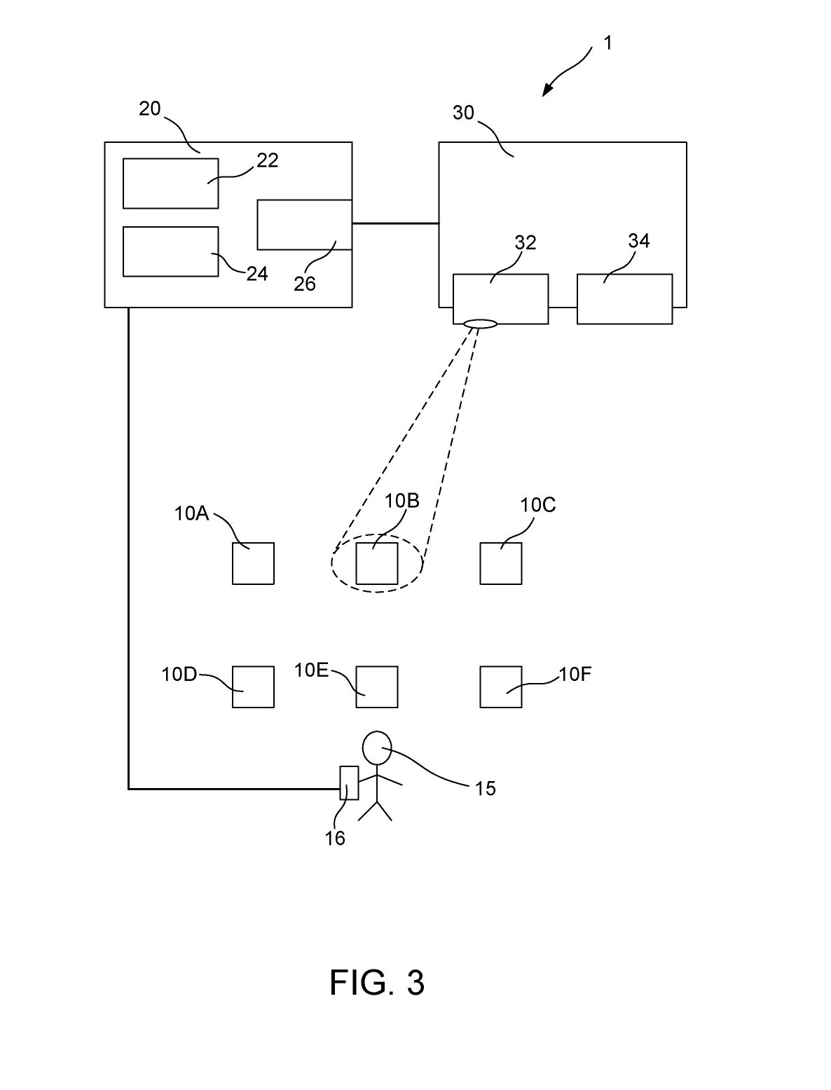

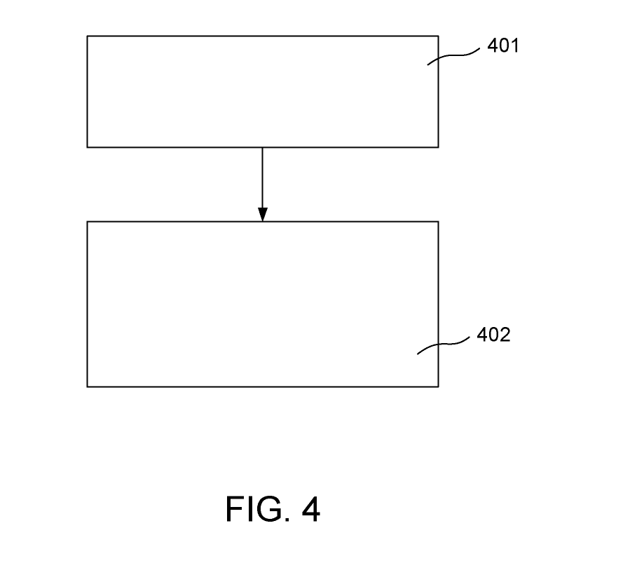

FIG. 3 illustrates yet an alternative embodiment of a system 1 for guiding a person in a decision making situation involving one or more physical objects 10A-10F. This embodiment resembles the system described in FIG. 1 but differs in that the object opinion registering device 20 according to this embodiment instead is arranged to receive opinion indications from a smart device 16 being arranged to be actuated by a person indicating an opinion related to at least one of the one or more physical objects (10A-10F). Thus, for details of the function of the object opinion registering device 20 and the object indicator 30 it is referenced to the above description. In FIG. 3. only one smart device 16 is depicted but the person skilled in the art realizes that multiple smart devices 16 may be used as well.

The one or more smart devices 16 are arranged to communicate with the opinion registering device 20. The communication may be implemented in various wireless ways, known to the person skilled in the art and will thus not be explained in more detail. The smart device being a hand held device with processing power, e.g. a smart phone, a tablet, a watch, etc. Information regarding the one or more physical objects may be acquired by the smart device scanning e.g. a NFC tag, a bar code or a QR code. The smart device may be used to register such a code or tag and thereafter an application installed on the smart device may be arranged to communicate with the object opinion registering device via e.g. the internet.

By interaction between the object opinion registering device 20 and the smart device 16 information pertaining to the physical objects can be seen on the smart device 16. In particular, the communication means can be Bluetooth, RFID, NFC, ZigBee or coded light (e.g. the light that is used to highlight the physical object can be coded such that information regarding the physical object is received by the smart device).

Information regarding the number of likings/disliking of a physical object or information of the rating of a physical object may be seen on the smart device 16. Moreover, information related to the number of likings/dislikings of a physical object or the rating of a physical object in relation to the sales of the physical object may be shown on the smart device 16. Sales can be calculated either across shops or within a shop.

The smart device may also be arranged to send the identity of the person using the smart device to the object opinion registering device 20.

In FIG. 3. a person 15 is liking the physical object 10E and thus actuate his smart device 16 such that an opinion indication indicating his liking is registered and being sent to the object opinion registering device 20 from the smart device.

A corresponding method for guiding a person in a decision making situation involving one or more physical objects 10A-10F is illustrated in FIG. 4. The method comprises the steps of registering 401, by means of an object opinion registering device 20, opinion indications of each of the one or more physical objects 10A-10F, and physically highlighting 402, by means of an object indicator 30, a physical object 10B, among the one or more physical objects 10A-10F, based on the registered opinion indications of each of the one or more physical objects 10A-10F.

The above disclosed features is also applicable to the corresponding method for guiding a person in a decision making situation involving one or more physical objects 10A-10F.

The person skilled in the art realizes that the present invention by no means is limited to the embodiments described above. On the contrary, many modifications and variations are possible within the scope of the appended claims. For example, sensors installed in shopping cards or inside the store may be used for gaining opinion indications.

Moreover, the actuators 12A-12F can be physically actuated with a finger, but also activated with a person's smart device, so that bidirectional information (user and object information) can be sent to/from the smart device and to/from the object. The latter may prevent that someone is actuating the actuator 12A-12F multiple times for the same physical object.

Instead of a physical button a touch-screen or touch-sensor can be used.

The object opinion registering device 20 can be arranged to track number of purchases and can change light and sound accordingly. By doing so, different features of light can reflect different purchasing parameters, e.g., intensity can reflect number of likes and color can reflect number of purchases.

The actuators 12A-12F can show how often the actuator 12A-12F is actuated relative to the number of times other objects are liked, either across object and shops or within any subset. The actuators 12A-12F can show how often the actuator 12A-12F is actuated relative to the sales of the object. Sales can be calculated either across shops or within a shop.

It is realized that the object opinion registering device 20 may be arranged to receive and register opinion indications from both the one or more actuators, the one or more cameras and/or the one or more smart devices.

In addition to light and sound, other signals targeting different human senses can be employed too. For instance, smell, temperature, visual attraction (displays, posters, etc.), luminous arrows on the floor, location indicators such as maps or GPS displays in the shopping cards, notifiers (i.e., alarms, indicators) in the smart devices can also be used to guide the user to and/or indicate the location of the liked object/area/shelf to the customers.

These signals can be used to indicate different or same aspects of the customer behavior. For instance light and sound can both be used to indicate if a certain object is liked more frequently. But alternatively, light can be used to indicate liking, and sound can be used to indicate that many people bought this object. Alternatively, one color of light can be used to indicate number of likes (in a more general sense statistics), and another color for light to indicate statistics of dislikes.

As stated above each one of these signals can be presented individually or in combination with other signals. Combinations can be made in different ways, such as making signals congruent, or resembling in terms of specific low level signal features.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An object opinion registering device arranged to register opinion indications related to one or more physical objects, the object opinion registering device comprising:
an input for receiving an opinion indication related to the one or more physical objects;
a controller, coupled to the input, arranged to register opinion indications received and further arranged to control an object indicator to physically highlight at least one of the one or more physical objects based on registered opinion indications;
at least one actuator, coupled to the input, the at least one actuator related to at least one of the one ore more physical objects, wherein the actuator is arranged to be actuated by persons indicating an opinion related to the at least one of the one ore more physical objects
a counter arranged to count the number and type of actuations for each of the one or more actuators, wherein the type of actuation is related to a person's opinion regarding a physical object and wherein the number and type of actuations for each of the one or more actuators is used for gaining the opinion indication of each one of the one or more objects.

2. The object opinion registering device according to claim 1, wherein the controller further comprises a connection to a wired or wireless network and is further arranged to control an object indicator based on data received from a device coupled to the wired or wireless network.

3. The object opinion registering device according to claim 1, wherein the controller further comprises a connection to a wired or wireless network and is further arranged for a device connected to the wired or wireless network to access registered opinion indications.

4. The object opinion registering device according to claim 1, wherein the object indicator comprises a lighting device arranged to physically highlight at least one of the one or more physical objects by directing light on the at least one physical object.

5. The object opinion registering device according to claim 4, wherein the lighting device is arranged to modulate intensity, color, color temperature, beam size and/or timing of the light directed on the at least one physical object.

6. The object opinion registering device according to claim 1, wherein the object indicator comprises a sound generating device arranged to physically highlight at least one of the one or more physical objects by creating a local soundscape in vicinity of the at least one physical object.

7. The object opinion registering device according to claim 6, wherein the sound generating device is arranged to modulate sound level, tempo, and/or content of the created local soundscape.

8. (canceled)

9. The object opinion registering device according to claim 1, further comprising at least one identification device arranged to register the identity of a person actuating the at least one actuator.

10. The object opinion registering device according to claim 1, further comprising a communication module, coupled to the input, arranged for receiving opinion indications from a smart device operated by a person indicating an opinion related to at least one of the one or more physical objects.

11. The object opinion registering device according to claim 1, further arranged to register opinion indications by receiving opinion indications from information registered by a camera, wherein the information registered by the camera is used for intelligent shopping behavior analysis giving information regarding opinion indications related to at least one of the one or more physical objects.

12. A system arranged to register opinion indications related to one or more physical objects and physically highlight at least one of the one or more physical objects, the system comprising:
the object opinion registering device according to claim 1; and
at least one object indicator;
wherein the at least one object indicator is arranged to physically highlight at least one of the one or more physical objects based on registered opinion indications.

13. A system comprising a plurality of opinion registering devices according to claim 1, wherein the controller of at least one object opinion registering device of the plurality of object opinion registering devices is coupled to at least one other object opinion registering device of the plurality of object opinion registering devices and is further arranged to control an object indicator based on registered opinion indications of the at least one other object opinion registering device.

14. A method for guiding a person in a decision making situation involving one or more physical objects, the method comprising:
registering, by means of an object opinion registering device, opinion indications related to at least one of the one or more physical objects; and
physically highlighting, by means of an object indicator, at least one of the one or more physical objects, based on the registered opinion indications of the at least one physical object.

15. A computer program product for guiding a person in a decision making situation related to one or more physical objects, the computer program product comprising computer program code for a programmable computer, the computer program code arranged for making the programmable computer perform the steps according to claim 14 when said computer program is run on the programmable computer.
